(19) United States
(12) Patent Application Publication
(10) Pub. No.: US 2009/0240428 A1
(43) Pub. Date: Sep. 24, 2009

(54) MOBILE PHONE HAVING GPS NAVIGATION SYSTEM

(76) Inventor: Maryam Shahrestani, Wayne, NJ (US)

Correspondence Address: OSTROLENK FABER GERB & SOFFEN, 1180 AVENUE OF THE AMERICAS, NEW YORK, NY, 100368403, US

(21) Appl. No.: 12/480,030

(22) Filed: Jun. 8, 2009

Related U.S. Application Data
(63) Continuation-in-part of application No. 11/958,914, filed on Dec. 18, 2007.
(60) Provisional application No. 60/936,222, filed on Jun. 18, 2007.

(51) Int. Cl. G01C 21/00

(52) U.S. Cl. 701/201

(57) ABSTRACT

A method of providing navigational instructions on a mobile device having an integrated GPS receiver, a geographic information system, and access to at least one database of addresses of geographic locations, each address having an association to a telephone number. The method includes the steps of establishing a present geographic location of the mobile device having integrated GPS receiver; inputting the telephone number identifying a destination; retrieving the address of the destination from the at least one database of addresses based on the input telephone number; and using the retrieved address of the destination and the present geographic location of the mobile device to request navigational instructions from the present geographic location to the destination. The retrieved navigational instructions to the destination and the present geographic location provide additional location based services (LBS) near the destination, or along the route from the location of the mobile phone to the location of the destination.

### CROSS-REFERENCE TO RELATED APPLICATION

This application is a continuation-in-part of U.S. application Ser. No. 11/958,914 filed Dec. 18, 2007 entitled Mobile Phone Having GPS Navigation System, the entire contents of which are incorporated by reference and further which claims the priority of U.S. Provisional Patent Application Ser. No. 60/936,222, filed on Jun. 18, 2007 and entitled MAPHONE, the entire contents of which are hereby incorporated by reference.

### BACKGROUND OF THE INVENTION

The present invention relates to mobile telephones and wireless devices and in particular, to mobile telephone and wireless devices equipped with an internal global positioning system (GPS) receiver and more particularly to navigation location search architecture built into the GPS enabled wireless device.

The Federal Communications Commission (FCC) requires wireless carriers to provide automatic location identification (ALI) for each wireless 911 call. This requirement may be achieved by equipping wireless phone devices with GPS receivers. Another approach includes a network based method that determines a position of the wireless phone devices by measuring angle of arrival (AOA) and time of arrival (TOA) of the wireless phone devices' signals at multiple fixed base stations. Yet another approach includes Assisted GPS (AGPS), which is a system in which outside sources, such as an assistance server (Mobile Location Server), are used to help the GPS via a network. Different service carriers use different solutions or a combination of these solutions to comply with the FCC's ALI regulation.

The main advantage of using GPS enabled devices is a ubiquitous access to the GPS. The GPS works 24 hours a day, anywhere in the world and in any weather conditions. In rural areas where there is a low density of base stations, use of the GPS is preferable over other approaches to the ALI regulation because it is more accurate. Using the GPS (including AGPS) rather than relying solely on AOA/TOA or other network based ALI techniques, allows the user greater access, accuracy, and independence. An additional benefit of the GPS based system is in that the navigation subsystem continues to operate, even when the cell phone signal is not available.

The invention of the GPS enabled emergence of a variety of trends in the communication technology including development of navigation devices, in particular portable GPS enabled devices, that can be used to transform the ground transportation navigation. In the past, guided travel from a location A to an unknown location B included using a geographic map printed on paper and optionally a navigator sitting next to the driver to read the map and instruct the driver how to proceed. This method is now replaced with directions being provided by GPS enabled devices that may be used to find both commercial and residential locations using addresses of these locations.

The inclusion of an integrated GPS receiver in a mobile phone (GPS phone), initially designed for emergency location of the GPS phone and its owner, as well as availability of access to an integrated or remote geographic information system (GIS) to the GPS phones, has eliminated the need for separate GPS navigation devices. Thus, this integration has combined navigational and communication devices into a single unit, i.e., the GPS phone, that provides communication and navigation information.

GPS phones also provide access to both static and real-time location based services. Location Based Services (LBS) are those services where the subscriber's geographic location is an integral or even the determining part of the service, for example, identifying the location of ATM machines, a fueling station or a hotel near the destination.

However, the use of the GPS phone remains difficult. For example, a user who wants to travel from the location A to the location B is required to key in the address information into the GPS phone. This requirement is exacerbated by the fact that entry of addresses requires use of a QWERTY keyboard. A standard telephone numeric keypad may also be used to enter alphanumeric information such as addresses, but such use is awkward, time consuming, and error prone.

Even worse, addresses can be erroneously recorded before entry into the GPS phone, for example, when clerks at stores and restaurants receive telephone orders, e.g., for food delivery, and write down the customers' addresses. Further errors in the addresses are quickly created when the recorded address is entered into the GPS phone, e.g., via the numeric keypad.

What is needed is a way to simplify the use of the GPS phone to obtain navigational instructions and other LBS.

U.S. Pat. No. 6,823,257, describes navigational assistance provided to the user of a cellular radiotelephone through the interplay between a service provider, telephone and geographic database providing the cell phone's location. However, the navigation described is non-GPS based and can only be implemented by the cellular network service provider, not on the cell phone itself. This means a lack of privacy, as the service provider is aware what directions were requested.

### SUMMARY OF THE INVENTION

It is an object of the present invention to provide an improved method of providing navigation for mobile phone users.

In particular, the invention provides a method for navigation for mobile phone users that utilizes the telephone number of the destination to request navigational instructions.

It is another object of the present invention to provide a method to minimize a need for of manual data entry of information into the GPS phone, thereby preventing potential errors due to data entry.

It is yet another object of the present invention to provide a method that minimizes manual data entry into the GPS phone by using numeric information, such as telephone numbers.

It is still another object of the present invention to provide a method that provides navigational instructions privately on the GPS phone itself.

A method of providing navigational directions using a mobile telephone having an internal GPS receiver is provided. The method includes the steps of automatically establishing an original position of a mobile telephone through the use of the internal GPS receiver; receiving destination information in said mobile telephone; converting the destination information to a destination position; and providing navigational directions from the original position to the destination position to a user of said mobile telephone through said mobile telephone.

Also provided is a method of providing navigational instructions on a mobile phone having an integrated GPS receiver, access to a geographic information system, and access to at least one database of addresses of geographic locations, each address having an association to a telephone number. The method includes the steps of establishing a present geographic location of the mobile phone having integrated GPS receiver; inputting the telephone number identifying a destination; retrieving the address of the destination from the at least one database of addresses based on the input telephone number; and using the retrieved address of the destination and the present geographic location of the mobile phone to request navigational instructions from the present geographic location to the destination.

A navigation system may be implemented in a mobile telephone by using an internal GPS receiver to obtain the mobile telephone's location. Geographic data for both the mobile telephone's location and the destination may be obtained from a geographic database. Accordingly, navigational assistance may be provided to the user of the mobile telephone using geographic data about the mobile telephone's location and a destination location. Additionally, the telephone may have an integrated database, or an access to an external database, storing address listings of both commercial and residential locations with telephone numbers tagged to the rows as a primary key. Thus, allowing the user of the telephone to input a telephone number as destination information, the address corresponding to that telephone number may be the destination location to which the user is traveling.

Additionally, a system for providing navigational instructions is provided. The system including a mobile phone having an integrated GPS receiver and access to at least one database of addresses of geographic locations, each address having an association to a telephone number; input peripherals on the mobile phone for inputting the telephone number identifying a destination; means for establishing a present geographic location of the mobile phone using latitude-longitude coordinates; means to access the at least one database of addresses to retrieve the address of the destination based on the input telephone number; and means to request navigational instructions from the present geographic location to the destination using the present geographic location and the retrieved address of the destination.

For example, a cashier receives a telephone call and enters an order for delivery to the customer's location. Then the delivery person needs only to enter the customer's telephone number on his cell phone, and then he would click to get directions. This reduces manual input and potential errors at two points in the process. The first is that the cashier who records the order does not ask for or enter the customer's address, and the second the delivery person does not need to key in the address. Also, the entry of a telephone number does not require a qwerty keypad and avoids the awkward and error prone method of using a standard telephone keypad to enter alpha-numeric information.

Additionally, it is desirable to provide a method and apparatus to display LBS information for the area near the route from the present geographic location to the destination using the present geographic location and the retrieved address of the destination.

According to one aspect, the invention comprises a method of providing navigational directions using a mobile device having an internal GPS receiver, the method comprising the steps of: automatically establishing an original position of the mobile device through the use of the internal GPS receiver; receiving destination information in said mobile device; converting the destination information to a destination position; and providing navigational directions from the original position to the destination position to a user of said mobile device through said mobile device, further comprising providing location based services (LBS) information from a geographical database.

It is furthermore desirable to be able to input and retrieve destination information for the visually impaired, for example, by using audio on the microphone/speaker to input destination information such as a telephone number or postal code and retrieving the destination information (address), via the audio speaker.

Other features and advantages of the present invention will become apparent from the following description of the invention that refers to the accompanying drawings.

### BRIEF DESCRIPTION OF THE DRAWINGS

FIG. 1 is a block diagram of a wireless GPS based navigation system in accordance with the present invention;

FIG. 2 is a diagram depicting a physical layout of the GPS phone;

FIG. 3 is a block diagram showing the data flow between a user interface, a telephone directory, the GIS subsystem, and a display of the GPS phone of FIG. 2 in accordance with the present invention;

FIG. 4 is a diagram depicting the data transformation from a telephone directory database record to comma-separated values (CSV) text.

FIG. 5 is a flowchart showing the process of updating a location in the telephone directory database;

FIG. 6 is a flowchart showing the process of checking for database updates;

FIG. 7 shows the transaction of retrieving addresses based on phone numbers from external services;

FIG. 8 shows software that allows a system to look up address information for known telephone numbers.

FIG. 9 is a diagram depicting a generalized physical architecture for a system providing LBS.

FIG. 10 is a message sequence diagram depicting the delivery of static LBS information.

FIG. 11 is a message sequence diagram depicting the delivery of dynamic LBS information via a “pull” model.

FIG. 12 is a message sequence diagram depicting the delivery of dynamic LBS information via a ‘push’ model.

### DETAILED DESCRIPTION OF EMBODIMENTS OF THE INVENTION

A system for providing navigational instructions may be implemented in the GPS phone by using the internal GPS receiver to obtain locations of the GPS phone and destination locations, e.g., fixed geographic locations. Geographic data for the location of the GPS phone and for the location of the destination may be obtained from a geographic database available, for example, on the Internet. Accordingly, assistance or navigational instructions may be provided to the user of the GPS phone using geographic data about the GPS phone's location and the destination location.

Because of their nature, mobile telephones do not have an address associated with its telephone number. Thus, if a second GPS phone is selected as the destination location, the geographic data for that destination location is determined by the on-board GPS receiver of the second GPS phone and transferred point-to-point to a first GPS phone or deposited in a mutually accessible location, e.g., the Internet.

Additionally, the GPS phone itself may include an integrated database or have access to an external database, for example, a database accessible over the Internet using wireless communication, for storing address listings of commercial and residential locations and telephone numbers corresponding to these locations tagged to the rows of addresses as primary keys. This will allow the user of the GPS phone to retrieve an address of the destination location by inputting a telephone number of the destination location. In other words, the telephone number is used to retrieve a corresponding address. The address is then used to request the navigational instructions to the destination.

The database for the integrated navigation subsystem of the GPS phone may comprise a parent data table consisting of the following fields: a phone number (Residential, Commercial), Name (Residential, Commercial), apartment number, Street Name, City, State, Zip Code, and Country.

A list of telephone numbers may be displayed by a user interface program on a display screen of the GPS phone. When a specific telephone numbers is selected, a get address function will issue a call from a user interface layer to build a structured query language (SQL) object with the following criteria: SELECT <Street Number>,<Street Name>, <City>, <State>, <Zip Code> from <Parent_table>where <Phone#>=<Ph# selected by user>. Another call is made to the database layer and the table is queried to return the desired value associated with the displayed telephone number. The fetched value is then passed through to the user interface layer and displayed on the user's screen.

A “Get Directions” function of the integrated navigation subsystem of the GPS phone then communicates with the GIS to issue the necessary direction routes. The last step follows the existing available GPS technology to provide navigational instructions.

The location data of the GIS that is available to the GPS enabled mobile telephone includes the address listings of both commercial and residential locations in a table structure. Although GIS may contain phone numbers for certain Points of Interest (POI), most addresses do not include corresponding telephone numbers. Further, the GIS address listing may not be complete and may use a geocoding estimate of the destination location.

Geocoding calculates spatial locations, i.e., latitude-longitude X, Y coordinates, from street addresses. A reference theme from the geodatabase is required to geocode individual addresses, such as a road centerline file with address ranges. Individual address locations are interpolated, or estimated, by examining address ranges along a road segment. These individual address locations are usually provided in the form of a table or a database. The GIS will then place a dot approximately where that address belongs along the segment of the centerline. For example, an address point of 500 will be at the midpoint of a line segment that starts with address 1 and ends with address 1000.

Address listings of commercial establishments and residential locations with associated telephone numbers are available through telephone directories, such as the 411 directories, the service providers' own directories, or other directory services that may be downloaded to the GPS phone. Thus downloaded data may be stored in the GPS phone's database as a local telephone directory of address listings of both commercial and residential locations with telephone number tagged to the rows as a primary key. This local telephone directory may provide quick phone number to address translation and the addresses then can be passed to the GIS to receive directions.

When traveling, the GPS phone may request downloads of telephone directories applicable to the GPS phone's new location. When anticipating travel, telephone directories corresponding to destinations along the travel route to a travel destination may be pre-loaded to the GPS phone. Similarly, updates to the geodatabase may be required when traveling.

Existing GPS phone based navigation systems include search functions that have search fields consisting of the following input fields: Street#, Street Name, City, State, and Zip Code. According to the invention, the search screen of the user interface (UI) of such navigation systems is required to be modified to include a new field: (field name=Phone Number; Type of the field=Number; Length of the field=10 Format=xxx-xxx-xxxx).

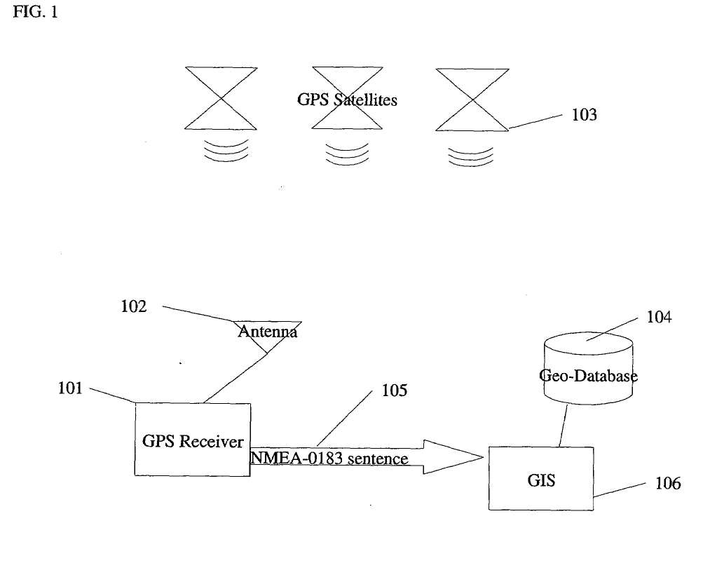

With reference now to the drawings, FIG. 1 shows the wireless GPS based navigation system in accordance with the present invention. The GPS subsystem determines the current location. Three GPS satellites 103, of the total of twenty-four GPS satellites 103 that circumnavigate the globe, are shown to transmit power radio signals at the frequency of 1575.42 MHz in the UHF band. The GPS signal contains three different pieces of information, i.e., a pseudo-random code, ephemeris data, and almanac data. The pseudo-random code identifies the transmitting satellite 103; the ephemeris data tells the GPS receiver where the GPS satellite 103 should be at any time throughout the day; and the almanac data, which is constantly transmitted by each satellite 103, contains important information about the status of the satellite, i.e., healthy or unhealthy, and current date and time. This part of the signal is essential for determining a position.

A GPS receiver 101 is shown to use an internal antenna 102 to capture GPS signals sent by the three GPS satellites 103. The GPS receiver 101 calculates pseudo ranges from the satellites to its own position. By receiving the GPS signals from the GPS satellites 103, the GPS receiver 101 compares the time each received signal was transmitted by the satellites 103 with the time the signal was received. Further, the GPS receiver 101 uses triangulation to calculate degrees longitude and latitude to determine its position. The positioning information computed by the GPS receiver 101 is outputted to the GIS 106 as NMEA-0183 data 105. The GIS 106 provide the tools to provision and administer base map data such as man made structures, e.g., streets and buildings, and the terrain, e.g., mountains and rivers. The GIS 106 is also used to manage point-of-interest data such as locations of gas stations, restaurants, nightclubs, etc.

In the preferred embodiments of the invention, GIS tools and the geodatabase both reside in the GPS phone unit. However, one or both may be accessed on a remote server via wireless connections. This remote server may be a part of a service provider's network or a web-based service accessed using WAP over an Internet gateway. Information exchange for web based applications may take place using GML as discussed in “Open Geospatial Consortium Inc.: GML Geography Markup Language, Version 3.00”, 29 Jan. 2003 Reference number: OGC 02-023r4 (GML Reference), especially when both GIS and geodatabase are remote. Information exchange may use the Open Geographic Datastore Interface (ODGI) when the GIS is local and the geodatabase is remote. ODGI is an application programming interface (API) that uses standardized access methods to work in conjunction with GIS software packages which may be used as the GIS 106 embedded application and various geospatial data products. OGDI supports client-server mode where a direct RPC connection is possible.

NMEA (National Marine Electronics Association) data is a standard format the GPS receivers 101 use to exchange information. NMEA is an ASCII data representation of a position, satellite data, and other data associated with the GPS receiver 101. Following is an example of a NMEA sentence 105:

$GPGGA,060003,3348.784,N,11754.064, W, 1,07,1.0,66.2,M,−31.9,M,,*45.

This sentence contains the position of N 33′ 48.784″ latitude, W 117′ 54.064″ longitude and an altitude of 66.2 meters. The time is showing 06:00:03 UTC. The GIS 106 decodes the NMEA sentence 105 and uses geographic data from a geographic database 104 to retrieve the geographic characteristics and map data for the current location.

The preferred embodiments of the invention use existing off-the-shelf GIS software. The internal storage format is not important to the invention. However, the ability to import standard or well-known proprietary formats may be required in the GIS software for embodiments of the invention. A common format for geographic data for the GIS is a ESRI Shapefile described in “ESRI Shapefile Technical Description”, An ESRI White Paper, ESRI, July 1998 (ESRI Reference). An ESRI Shapefile stores non-topological geometry and attribute information for the spatial features in a data set. The geometry for a feature is stored as a shape comprising a set of vector coordinates.

Because the ESRI Shapefile does not have the processing overhead of a topological data structure, they have advantages over other data sources such as faster drawing speed and edit ability. ESRI Shapefiles handle single features that overlap or that are noncontiguous. They also typically require less memory and are easier to read and write. The ESRI Shapefile can support point, line, and area features. Area features are represented as closed loop, double-digitized polygons. Each attribute record has a one-to-one relationship with the associated shape record.

Two standards are dominating the digital maps' landscape in conjunction with the provision of navigation services: Geographic Data Files (GDF) (see ISO14825: 2004, Intelligent Transport Systems—Geographic Data Files—Overall Data Specification (GDF4.0), ISO, 2004 Feb. 15 (GDF Reference)), an ISO standard to describe and transfer road networks and other transportation related data, and the GML (see GML Reference) is the XML grammar defined by the Open Geospatial Consortium (OGC) to express geographical features. The GML is a modeling language for geographic systems as well as an open interchange format for geographic transactions. The GDF is the main reference as far as the automotive sector is concerned, whereas the GML is the main reference in the domain of the GIS.

The topological model of the GML is useful to encode a GML representation, e.g., of a road network of a city, of a country, and so on. In this way routing problems for instance, formulated over the GML representation of a road network, can be addressed by looking at the topology of the network. The topology model encodes intersections as nodes, road segments as edges and the connective relationships between the edges and nodes, all the information, therefore, needed to solve complex routing issues.

Many current off-the-shelf GIS software solutions support the ESRI Shapefile, GDF and GML. The GIS for this invention should be capable of importing data in all of these formats, regardless of how/or if they store data locally. In some embodiments of the invention data is imported on demand by the GIS when a user requests directions.

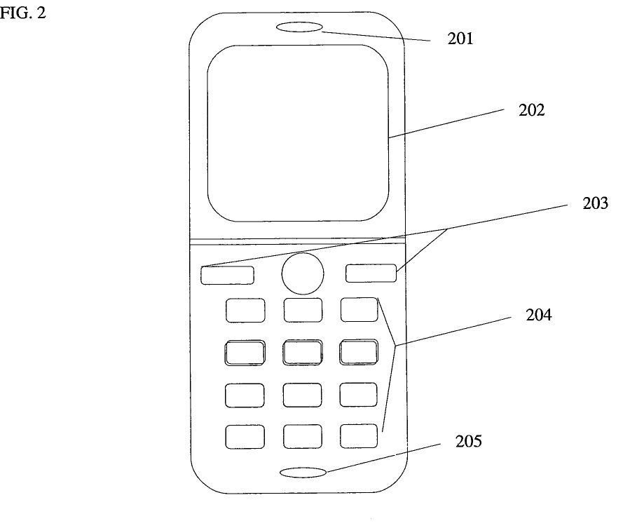

FIG. 2 is a diagram illustrating a physical layout of a preferred non-limiting example of the GPS phone. As shown, the GPS phone may include a display 202, an alphanumeric keypad 204, menu navigation keys 203; a microphone 205 that can be used for issuing voice activated directives to a speech recognition system, and a speaker 201 that can be used to issue audible navigation directions to the user. The display 202 can be a touch screen display or any other type of display known to the skilled artisan, which can present a graphical user interface. A hands-free arrangement is desirable for use in a vehicle.

To operate the GPS phone of the present invention, after being presented with a list of phone numbers of business or individuals, e.g., last called numbers, last received numbers, a directory, a personal phone book, etc. on the display 202, a user may select a travel destination from the list by using one of the following: the navigation keys 203; voice commends spoken into the microphone 205; and typing on the keypad 204.

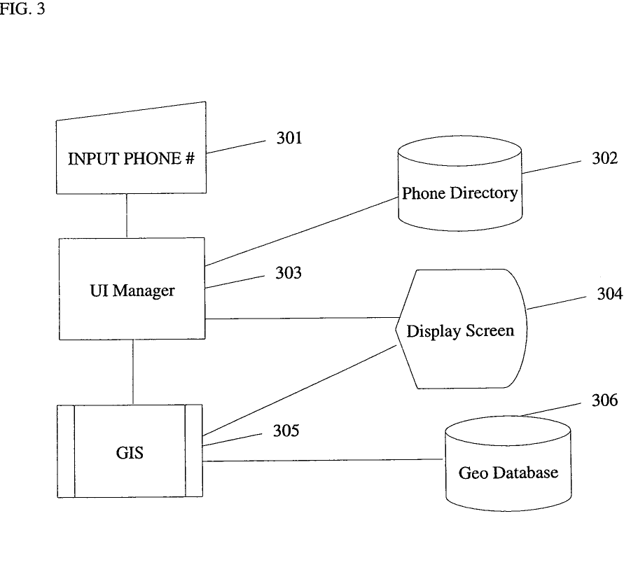

As shown in FIG. 3, the user enters a telephone number as the destination information 301. The GPS phone may be equipped with memory to locally store a telephone number-address database 302. Alternatively, the database 302 may be remotely stored. Thus, when a user enters a telephone number into the GPS enabled mobile telephone via the keypad entry, voice command or the like, a user interface UI manager 303 can access the telephone directory 302 using an SQL query to retrieve the requested record, and strips the name and phone number from the record to present the GIS 305 with the address in the desired ASCII text with comma separated value (CSV) format and including the following fields: <Street number>,<Street Name>, <City>, <State>, <Zip Code>.

The UI Manager 303 passes the CSV formatted address to the GIS 305 requesting navigation from the current location to the destination indicated by the selected address. The GIS geocodes the address to the X, Y location and retrieves geographic information from the geodatabase 306. The GIS displays the directions and/or a map to the destination on the display screen 304, which is the screen 202 of FIG. 2.

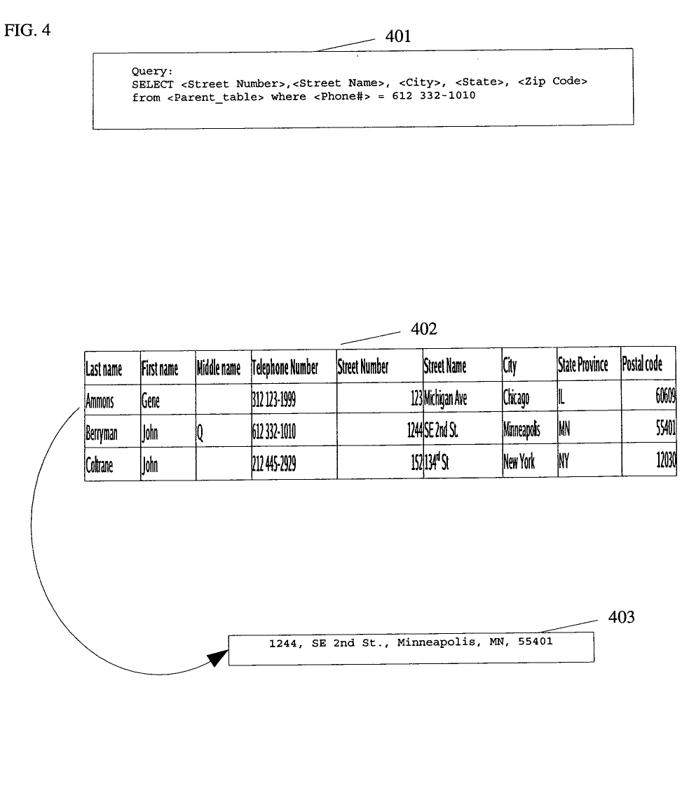

FIG. 4 shows an exemplary query 401 that the UI manager may issue to a Telephone Directory Database 402. The query 401 will select and retrieve the desired field, from the row containing the specified phone number. The resulting value returned would be a CSV text record 403 that may be transferred to the GIS.

Because of memory limitations in small devices, and because certain data is subject to change, both the telephone directory database 402 and the geodatabase 306 (FIG. 3) may require over the air (OTA) updates. These updates may be triggered by any one of the following events

1. Automatically when existing data becomes obsolete and new data becomes available. The GPS phone may periodically, e.g., monthly, check for the availability of updated information;

2. Automatically when the GPS phone moves into an area not covered by the currently installed databases. The GPS phone may frequently, e.g., hourly, check its location and check the availability to relevant telephone directory and geodatabase information for its current location;

Explicitly by a user requesting a download of a database of planned travel destination; and

Implicitly by a user selecting a travel destination outside areas covered by the currently installed databases.

Providers of wireless data services have recognized a tremendous potential in offering anytime wireless access to new applications and services to their subscribers. For this reason, the wireless carriers have invested heavily in the network infrastructure capable of effectively delivering data to handsets using technologies such as a Wireless Application Protocol (WAP). Thus any service provider may enable a server to respond to authenticated requests for database downloads.

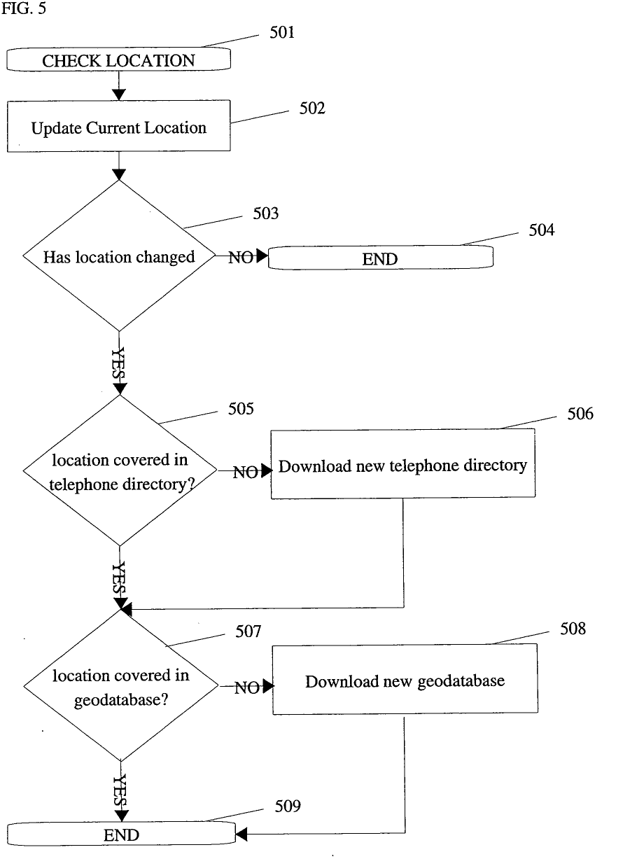

FIG. 5 shows a Check Location process 501 that is scheduled to run frequently, e.g., hourly. First, the process 501 updates the current location of the GPS phone via the update current location process 502. At step 503, the process 502 determines if the present location has moved into a new region. If the location has not changed, the process 502 ends at step 504. If the location has changed, in step 505 the telephone directory is checked to determine if it includes the new location. If the telephone directory doesn't include the new location a download of a directory that includes the new location is initiated in step 506, after which the process 502 proceeds at step 507.

In step 507, the geodatabase is checked to see if it includes the new location. If the geodatabase includes the new location the process ends at step 509. If the geodatabase doesn't include the new location a download of the geodatabase that includes the new location is initiated in step 508, after which the process ends at step 509.

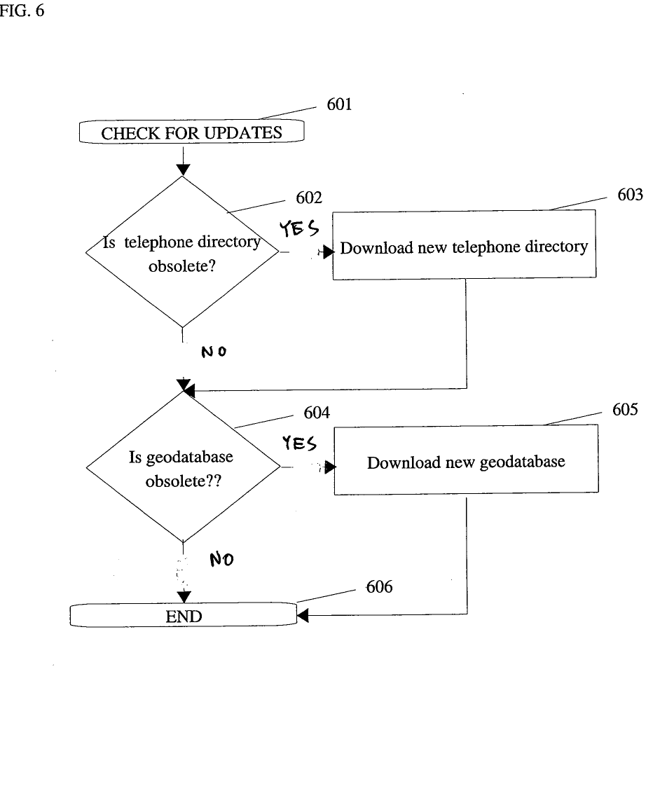

FIG. 6 depicts the Check For Updates process 601 that is scheduled to run frequently, e.g., hourly. In step 602, the telephone directory is checked to see if it is obsolete. If the telephone directory is obsolete an updated telephone directory download is initiated in step 603, after which the process 601 continues at step 604. At step 604, the geodatabase is checked to see if it is obsolete. If the geodatabase is not obsolete the process ends at step 606. If the geodatabase is obsolete an updated geodatabase is downloaded in step 605 and the process ends in step 606.

In some embodiments of the invention, the telephone number to address function is provided via a remote server either owned by the wireless service provider or by a commercial web service either instead of or in addition to the local telephone directory query. GPS enabled mobile phone can use an Internet connection (though the WAP gateway of the service provider) to retrieve address information from a remote server using secure Simple Object Access Protocol (SOAP). SOAP is an XML-based, extensible message envelope format, with “bindings” to underlying protocols. The primary protocols are HTTP and HTTPS. SOAP forms the foundation layer of the Web services stack, providing a basic messaging framework that more abstract layers can build on.

In some embodiments of the invention the local directory and the remote server are used. Rather than downloading new directories when traveling to regions not contained in the local telephone directory database as described in relation to the process flow of FIG. 5, the GPS phone switches to a mode of operation using the remote web server. In other embodiments of the invention, there is no local database and the GPS phone always relies on the web service.

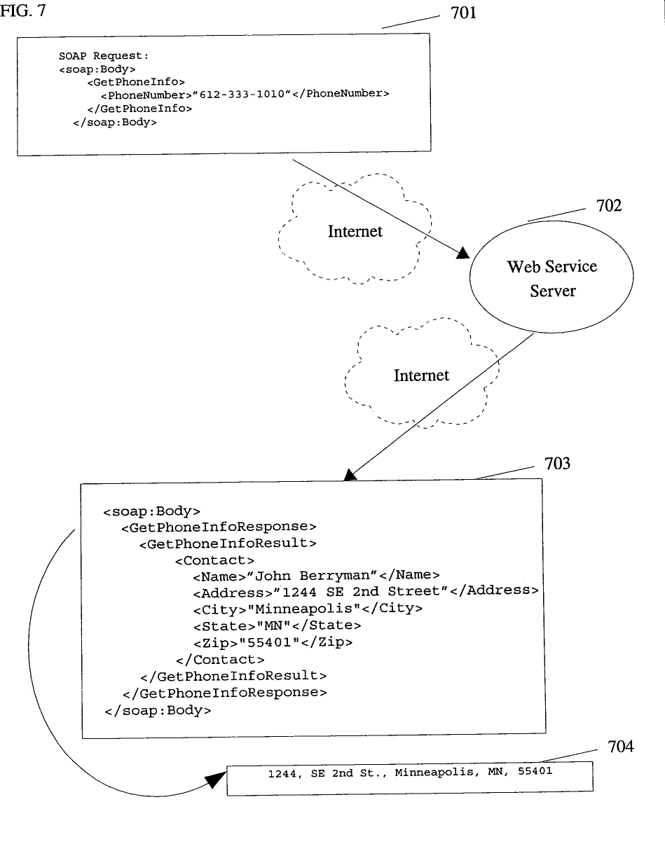

FIG. 7 depicts an embodiment of the present invention that uses a web service server 702 provided by Service Objects' DOTS GeoPhone. GeoPhone is a commercial service that allows integrated reverse phone number lookup using SOAP over an Internet connection to retrieve address information from a remote server. In this case, rather than storing telephone number/address pairs in the local database, the GPS phone replaces the local query 401 described with reference to FIG. 4 with a SOAP request 701 issued to the Web Service provider's server 702. The SOAP response 703 is then decoded and the relevant fields are formatted into CSV format 704 to be delivered to the GIS.

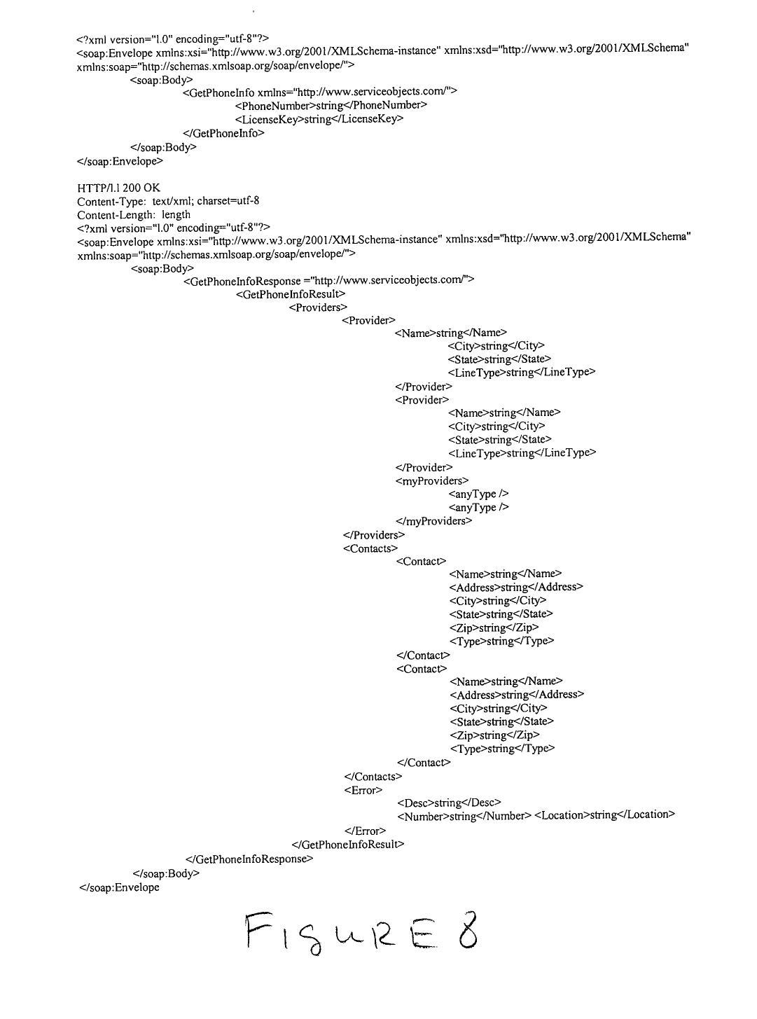

Service Objects' DOTS GeoPhone is a hosted, programmable XML Web Service that allows a system to lookup name and postal address information for virtually every U.S. telephone number. An example of a SOAP request and response using the commercial Service Objects' DOTS GeoPhone multi-database XML Web Service is illustrated in FIG. 8. An exemplary format of the SOAP request and response fields for use with the present invention are shown in Tables 1 and 2.

TABLE 1
SOAP Request Fields

| Name’ | Type’ | Description |
|---|---|---|
| PhoneNumber’ | String’ | Phone number to look up, for example, |
| | | “805-963-1700” |

TABLE 2
SOAP Response Fields

| Name | Type | Values | Description |
|---|---|---|---|
| Name (Provider) | String | Varies | The name of the line carrier of the phone |
| | | | number (“AT&T”) |
| City (Provider) | String | Varies | The city location of the carrier's exchange |
| | | | (“New York”) |
| State (Provider) | String | Varies | The state location of the carrier's |
| | | | exchange (“NY”) |
| LineType | String | Landline/Wireless/ | No address returned if wireless or |
| | | Unknown | unknown |
| Name (Contact) | String | Varies | The name that the phone line is registered |
| | | | to. Can either be a person (“John Doe”) |
| | | | or a business (“Doe Corporation”) |
| Address (Contact) | String | Varies | The street address to which the phone line |
| | | | is registered |
| City (Contact) | String | Varies | The city to which the phone line is |
| | | | registered |
| State (Contact) | String | Varies | The state to which the phone line is |
| | | | registered |
| Zip (Contact) | String | Varies | The zip code to which the phone line is |
| | | | registered |
| Type (Contact) | String | Residential/Business/ | The type of entity that owns the phone |
| | | Unknown | line, will be either “Residential” or |
| | | | “Business” |

A use case scenario further explaining the use of the invention is provided as follows:

The user's home phone telephone number and a phone number of a friend are recorded in the user's GPS phone;

On the GPS phone the user accesses and searches the address book feature of the GPS phone and displays the home and the friend's phone numbers on the display screen 202 (FIG. 2);

Using the navigation key 203 (FIG. 2) the user requests details for the selected phone numbers;

A representation of a function to get the address associated with the selected phone number is displayed on the screen display 202, which the user then selects using navigation keys 203 or voice commands;

Once the function to get the address is selected, a search criteria is invoked and the address associated with the selected telephone number is presented on the display screen 202; and

When the address is available on the GPS phone, the “Get Directions” feature of the GPS phone is executed to get the Direction list for the provided address using navigation keys 203.

Sometimes, a need may arise to find directions using a telephone number that is not associated with an address. Instead, the telephone number may be of a roaming target, for example cell or mobile phones. The locations information of such roaming phones, may be determined by on-board GPS receivers, and transmitted to a central location, e.g., the Internet based database system, where the data is recorded. Alternatively, the location information determined by the on-board GPS receiver can be shared or transmitted between two cell/mobile phones when these phones are connected, i.e., a phone call is made from one phone to another.

Thus, when a first mobile phone having an integrated GPS receiver requests navigational information to a roaming mobile telephone using that roaming mobile telephone's number, the roaming mobile telephone's number can be used to retrieve the roaming mobile telephone's location GPS longitude-latitude coordinates. As discussed, these coordinates may be retrieved from the roaming mobile telephone itself or from a database, e.g., the Internet based database. Once received the latitude-longitude coordinates of the roaming mobile telephone are converted into the destination address.

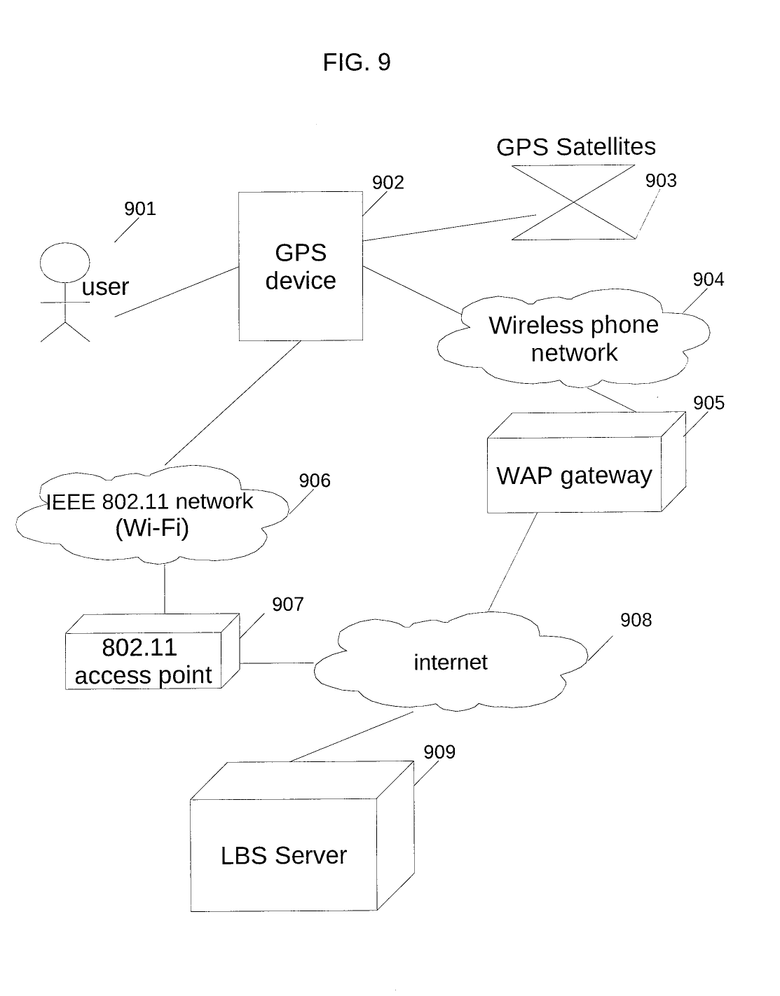

Providers of wireless data services have recognized a tremendous potential in offering both static and real time LBS to their subscribers. For this reason, the wireless carriers have invested heavily in the network infrastructure capable of effectively delivering LBS data to handsets. Thus any service provider may enable a server to respond to authenticated requests for LBS. FIG. 9 depicts the generalized physical architecture of this infrastructure.

Delivering LBS data to handsets using technologies such as a Wireless Application Protocol (WAP) gateways 905 and wireless phone network 904 using technologies such as 3G networks which enable network operators to offer users 901 with LBS while achieving greater network capacity through improved spectral efficiency.

In some embodiments of the invention a portable GPS enabled device 902 may only have access to IEEE 802.11 networks 907, which are commonly called Wi-Fi and may provide internet 908 access via and access point 907. Network connectivity provides authenticated access to remote LBS servers 909 which can provide both static LBS, such as location of ATM's and other Points of Interest (POI) and realtime LBS. such as traffic information. weather. and location specific advertising.

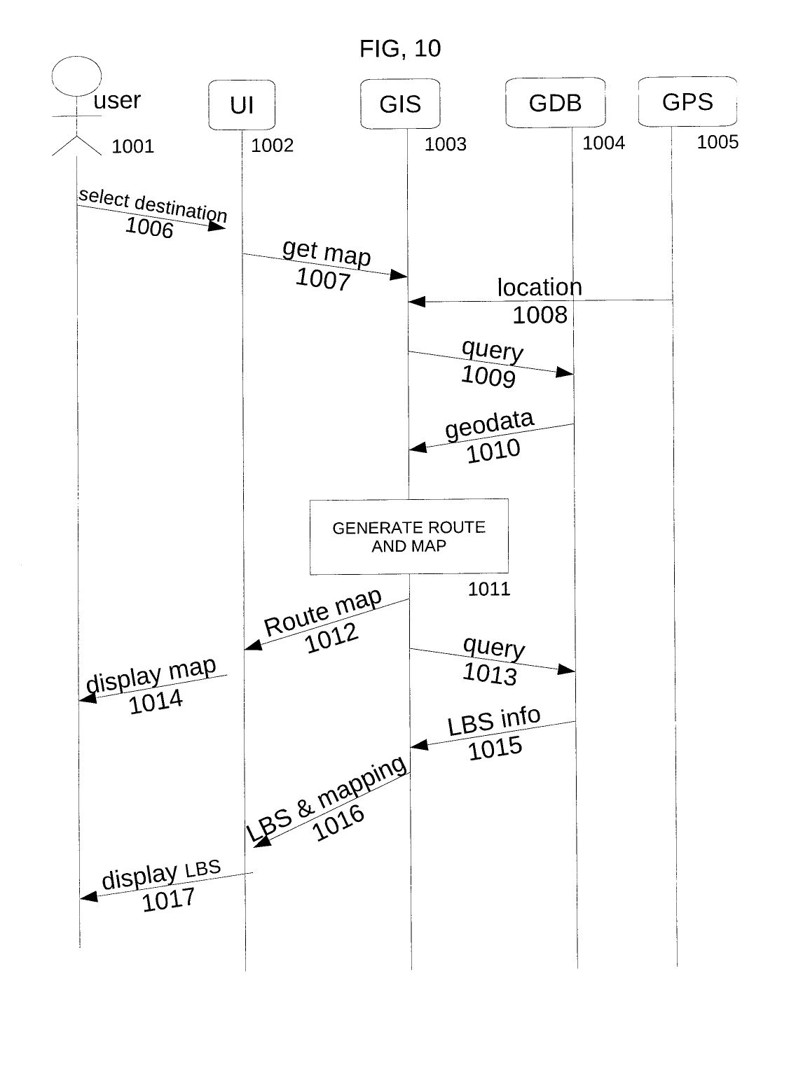

FIG. 10 depicts a scenario in which static LBS is contained in a local database. In this scenario a user 1001 selects a destination 1006 by using a method such as entering a telephone number or a postal (zip)code as the destination information. The user interface UI manager 1002 requests a map 1007 from the GIS 1003. The GIS 1003 reads the current location 1008 from the embedded GPS 1005. The GIS 1003 sends a database query 1009 to the geodatabase 1004 which responds with the matching geodata 1010. The GIS processes the geodata 1011 and sends the resulting route map 1012 to the UI manager 1002. The UI manger then displays the map 1014 on the display screen 202. The GIS uses points along the generated route and sends another query 1013 to the geodatabase 1004 which responds with LBS information 1015 for those points. The GIS supplements the LBS data with mapping data 1016 and sends it to the UI manager 1002, which displays the LBS information graphically in the map display 1017.

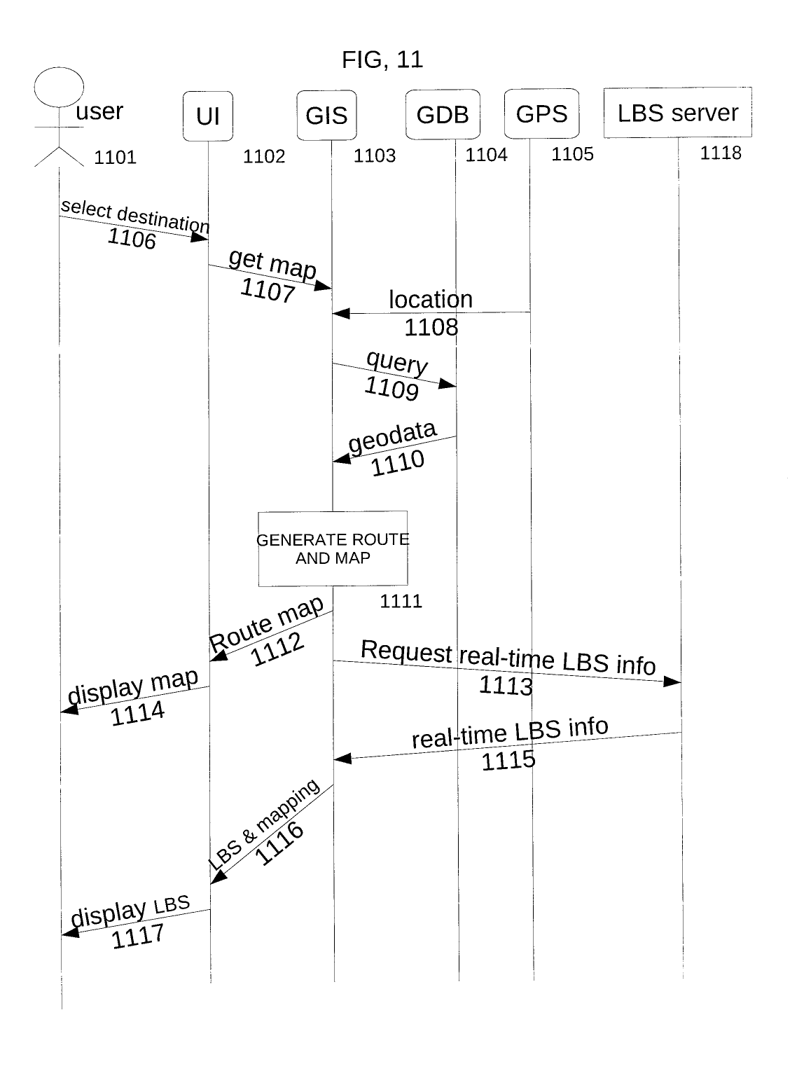

FIG. 11 depicts a scenario in which real-time LBS is retrieved from a remote database. In this scenario a user 1101 selects a destination 1106 by using a method such as entering a telephone number or postal code as the destination information. The UI manager 1102 requests a map 1107 from the GIS 1103. The GIS 1103 reads the current location 1108 from the embedded GPS 1105. The GIS 1103 sends a database query 1109 to the geodatabase 1104 which responds with the matching geodata 1110. The GIS 1103 processes the geodata 1111 and sends the resulting route map 1112 to the UI manager 1102. The UI manger then displays the map 1114 on the display screen 202. The GIS uses points along the generated route and sends another query 1113 to a remote LBS server 1118 which responds with realtime LBS information 1115 for those points. The GIS supplements the LBS data with mapping data 1116 and sends it to the UI manager 1102. which displays the LBS information graphically in the map display 1117.

In some embodiments of the invention real-time LBS are ‘pushed’ to the subscriber by the provider. These may include traffic updates, weather, the least expensive gas station nearby, etc.

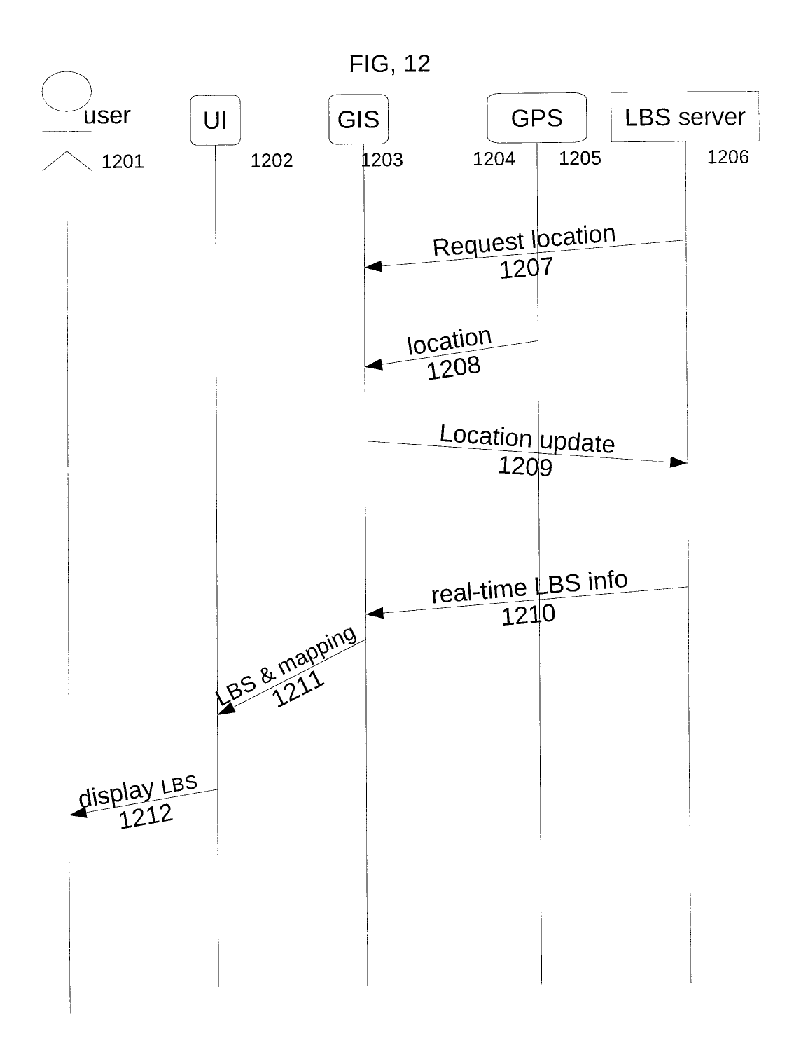

FIG. 12 depicts a scenario in which real-time LBS is pushed to subscriber from a remote LBS server autonomously The remote LBS server 1206 polls the GPS enabled device by send a request for the device's current location 1207. The GIS 1203 reads the current location 1207 from the embedded GPS 1205. The GIS then sends the location update 1209 to the remote LBS server 1206. The LBS server then sends real-time LBS information 1210 for the updated location to the GIS 1203. The GIS 1203 supplements the LBS data with mapping data 1211 and sends it to the UI manager 1211, which displays the LBS information graphically in the map display 1212.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

For example, many of the functions described herein as being performed with a mobile phone, could be performed with another GPS enabled wireless device, such as a PDA or hand held computer. Also, as mentioned earlier, Phone Directories, GIS and Geo database may each or all be implemented external to the GPS enabled telephone and accessed remotely. Also, communication specified using WAP over an Internet gateway from the service provider could also be performed with different protocols including IEEE 802.11 for wireless LAN, IEEE 802.16 for wireless broadband and others.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method of providing navigational directions using a mobile device having an internal GPS receiver, the method comprising the steps of:
automatically establishing an original position of the mobile device through the use of the internal GPS receiver;
receiving destination information in said mobile device;
converting the destination information to a destination position;
providing navigational directions from the original position to the destination position to a user of said mobile device through said mobile device, and
further comprising providing location based service (LBS) information from a geographical database.

2. The method of claim 1, wherein the destination information comprises a telephone number or a postal code of the destination.

3. The method of claim 2, wherein the step of converting said destination information comprises the step of converting said telephone number or postal code to a corresponding address representing said destination position.

4. The method of claim 1, wherein the step of providing LBS information comprises providing the LBS information from a geographical database disposed in said mobile device.

5. The method of claim 1, wherein the step of providing LBS information comprises providing the LBS information from a remote server.

6. The method of claim 5, wherein the LBS information is pulled from the server.

7. The method of claim 5, wherein the LBS information is pushed from the server.

8. The method of claim 5, wherein the LBS information is real time.

9. The method of claim 1, further comprising displaying LBS information for the area near the destination position and the area along the route from a current position to the destination position.

10. The method of claim 1, further comprising providing a user input means on the mobile device to request display of LBS information.

11. The method of claim 1, wherein the mobile device comprises a display, a numeric keypad, a microphone, at least one navigational function key, and the step of receiving destination information comprises inputting via one or more of keying on the numeric keypad, speaking into the microphone, and using the at least one navigational function key.

12. The method of claim 1, further comprising initiating display of LBS information automatically when LBS information is displayed in the form of graphics on a map on a display of the mobile device.

13. The method of claim 1, wherein real-time LBS information is retrieved from a remote database.

14. The method of claim 1, wherein input peripherals on the mobile device include one or more of a numeric keypad, a microphone, and at least one navigational function key for selecting at least one of a plurality of telephone numbers from a display and output peripherals on the mobile device include one or more of a display and a speaker.

15. The method of claim 14, wherein the navigational directions from the present geographic location to the destination position are provided on a peripheral of the mobile device selected from at least one of audio on the speaker, textual list of partial steps provided on the display, and a graphic representation of a route map provided on the display.

16. The method of claim 1, wherein the destination information can be input via an audio device of the mobile device and the destination information can be retrieved via an audio device of the mobile device, thus facilitating use by the visually impaired.

17. The method of claim 1, wherein the LBS information including Points of Interest (POI).

18. Apparatus for providing navigational directions using a mobile device comprising:
a GPS receiver for establishing an original position of the mobile device;
an input device for receiving destination information in said mobile device;
the mobile device including circuitry to access a device for converting the destination information to a destination position;
a device providing navigational directions from the original position to the destination position to a user of said mobile device through said mobile device, and
further wherein the mobile device includes means providing location based service (LBS) information from a geographical database.

19. The apparatus of claim 18, wherein the destination information comprises a telephone number or a postal code of the destination.

20. The apparatus of claim 19, wherein the device for converting said destination information converts said telephone number or postal code to a corresponding address representing said destination position.

21. The apparatus of claim 18, wherein the means providing LBS information comprises a geographical database disposed in said mobile device.

22. The apparatus of claim 18, wherein the means providing LBS information comprises a remote server.

23. The apparatus of claim 22, wherein the LBS information is pulled from the server.

24. The apparatus of claim 22, wherein the LBS information is pushed from the server.

25. The apparatus of claim 22, wherein the LBS information is real time.

26. The apparatus of claim 18, further comprising a display for the LBS information for the area near the destination position and the area along the route from a current position to the destination position.

27. The apparatus of claim 18, further comprising a user input means to request display of LBS information.

28. The apparatus of claim 18, wherein the mobile device comprises a display, a numeric keypad, a microphone, at least one navigational function key, and the destination information is input via one or more of keying on the numeric keypad, speaking into the microphone, and using the at least one navigational function key.

29. The apparatus of claim 18, further wherein display of LBS information is initiated automatically when LBS information is displayed in the form of graphics on a map on a display of the mobile device.

30. The apparatus of claim 18, wherein real-time LBS information is retrieved from a remote database.

31. The apparatus of claim 18, wherein input peripherals on the mobile device include one or more of a numeric keypad, a microphone, and at least one navigational function key for selecting at least one of a plurality of telephone numbers from a display and output peripherals on the mobile device include one or more of a display and a speaker.

32. The apparatus of claim 31, wherein the navigational directions from the present geographic location to the destination position are provided on a peripheral of the mobile phone selected from at least one of audio on the speaker, textual list of partial steps provided on the display, and a graphic representation of a route map provided on the display.

33. The apparatus of claim 18, wherein the destination information can be input via an audio device of the mobile device and the destination information can be retrieved via an audio device of the mobile device, thus facilitating use by the visually impaired.

34. The apparatus of claim 18, wherein the LBS information includes Points of Interest (POI).
